(19) United States
(12) Patent Application Publication
(10) Pub. No.: US 2025/0231811 A1
(43) Pub. Date: Jul. 17, 2025

(54) METHOD AND DEVICE FOR CLASSIFYING DATA AND ALLOCATING BLOCKS USING BIT ERROR RATE

(71) Applicant: KOREA ADVANCED INSTITUTE OF SCIENCE AND TECHNOLOGY, Daejeon (KR)

(72) Inventors: Myoungsoo JUNG, Daejeon (KR); MinYoung CHOI, Daejeon (KR); Miryeong KWON, Daejeon (KR)

(73) Assignee: KOREA ADVANCED INSTITUTE OF SCIENCE AND TECHNOLOGY, Daejeon (KR)

(21) Appl. No.: 18/930,400

(22) Filed: Oct. 29, 2024

(30) Foreign Application Priority Data
Jan. 11, 2024 (KR) 10-2024-0005058
Jun. 14, 2024 (KR) 10-2024-0077467

(51) Int. Cl. G06F 9/50; G06F 11/00

(52) U.S. Cl. CPC G06F 9/5038; G06F 9/5044; G06F 11/008

(57) ABSTRACT

A method and an apparatus for classifying data and allocating blocks using the bit error rate. According to an embodiment of a present disclosure, a method for classifying data and allocating blocks using the bit error rate includes classifying data into first data and second data using information on quality of service (QoS) and a bit error rate. The method also includes determining a group ID using the information on QoS and a mapping table. The method also includes acquiring a block from an idle block pool of a group based on the group ID using the group ID. The method also includes allocating the block to the first data or the second data.

### CROSS-REFERENCE TO RELATED APPLICATIONS

The present application is based on, and claims priority from, Korean Patent Application No. 10-2024-0005058 filed on Jan. 11, 2024, and Korean Patent Application No. 10-2024-0077467 filed on Jun. 14, 2024, the disclosure of which is incorporated by reference herein in its entirety.

### TECHNICAL FIELD

The present disclosure relates to a method and device for classifying data and allocating blocks using the bit error rate. More specifically, the present disclosure relates to a method and device for classifying data using information on quality of service (QoS), and managing blocks as groups, and allocating the blocks to the data.

### BACKGROUND

The content to be described below merely provides background information related to the present embodiment and does not constitute the related art.

In a NAND flash memory, a program is erased by repeating a process of injecting electrons into a floating gate and releasing the electrons. This process is called a program/erase (P/E) cycle, and when the P/E cycle increases, charges are trapped in an oxide layer and a defect such as oxide cracks occurs. The defect increases a raw bit error rate (RBER). According to the Joint Electron Device Engineering Council (JEDEC) standard, a solid state drive (SSD) should guarantee a bit error rate lower than 10⁻¹⁵. To guarantee the low bit error rate, the solid state drive increase the number of pieces of information to be referenced when data reading fails. However, in this case, there is a problem that a latency increases due to the increasing number of times reading is performed.

When a low density parity check (LDPC) level is low, a low latency in data processing is provided, but an allowable raw bit error rate is low. This means that an error occurs even with a small number of times of P/E, and a lifespan of the application is short. When the LDPC level is high, a long lifespan of the application is provided, but the latency in data processing increases. Accordingly, research is needed to achieve both a low latency in data processing and a long lifespan of the application using the self-resilience of the application.

### SUMMARY

An object of the present disclosure is to perform classification into data of which a low bit error rate should be guaranteed and data of which a low bit error rate needs not to be guaranteed.

According to an embodiment, another object of the present disclosure is to manage blocks using a plurality of groups and allocate the blocks to data.

The problems to be solved by the present disclosure are not limited to the problems described above, and other problems that are not described can be clearly understood by those skilled in the art from the description below.

According to the present disclosure, a method for classifying data and allocating blocks using the bit error rate includes classifying data into first data and second data using information on quality of service (QoS) and a bit error rate. The method also includes determining a group ID using the information on QoS and a mapping table. The method also includes acquiring a block from an idle block pool of a group based on the group ID using the group ID. The method also includes allocating the block to the first data or the second data.

According to the present disclosure, an apparatus for classifying data and allocating blocks using the bit error rate includes a memory and a plurality of processors. At least one of the plurality of processors is configured to classify data into first data and second data using information on QoS and a bit error rate. The at least one of the plurality of processors is also configured to determine a group ID using the information on QoS and a mapping table. The at least one of the plurality of processors is also configured to acquire a block from an idle block pool of a group based on the group ID using the group ID. The at least one of the plurality of processors is also configured to allocate the block to the first data or the second data.

According to the present disclosure, a computer-readable recording medium is a computer-readable recording medium storing instructions, the instructions, when executed by the computer, may cause the computer to perform classifying data into first data and second data using information on quality of service (QoS) and a bit error rate. The instructions, when executed by the computer, may also cause the computer to perform determining a group ID using the information on QoS and a mapping table. The instructions, when executed by the computer, may also cause the computer to perform acquiring a block from an idle block pool of a group based on the group ID using the group ID. The instructions, when executed by the computer, may also cause the computer to perform allocating the block to the first data or the second data.

According to the present disclosure, there is an effect that it is possible to simultaneously guarantee a long lifespan of an application and a low latency in data processing.

Further, according to an embodiment, there is an effect that it is possible to allocate an optimal block to each piece of data to satisfy a latency required by an application.

The effects that can be obtained from the present disclosure are not limited to the effects described above, and other effects that are not described can be clearly understood by those skilled in the art to which the present disclosure belongs from the description below.

### BRIEF DESCRIPTION OF THE DRAWINGS

FIG. 1 is a diagram illustrating a relationship between a raw bit error rate (RBER) and a post bit error rate (PostBER) depending on a low density parity check (LDPC) level and a distribution of a probability density function (PDF) depending on the RBER according to an embodiment of the present disclosure.

FIG. 2 is a block diagram illustrating a device for classifying data and allocating blocks to the data according to an embodiment of the present disclosure.

FIG. 3 is a diagram illustrating a method of transferring information on quality of service (QoS) to a solid state drive according to an embodiment of the present disclosure.

FIG. 4 is a diagram illustrating a method of allocating blocks to data according to an embodiment of the present disclosure.

FIG. 5 is a flowchart illustrating a method of classifying data and allocating blocks to the data according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

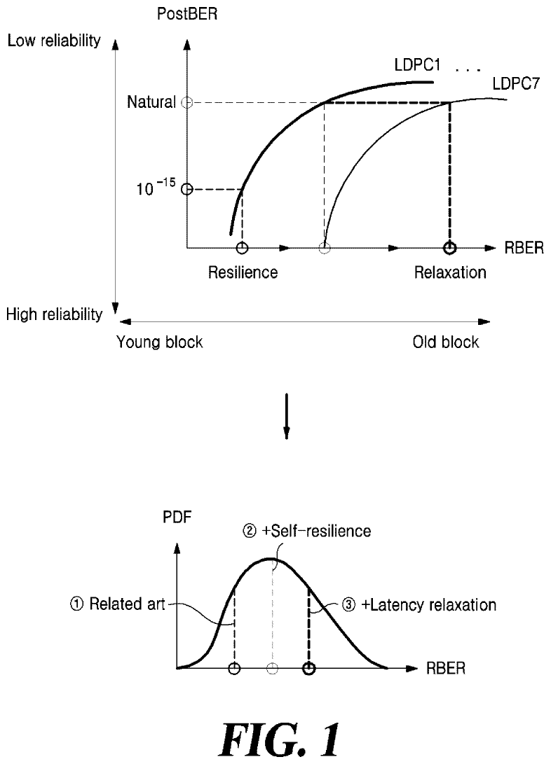

FIG. 1 is a diagram illustrating a relationship between a raw bit error rate (RBER) and a post bit error rate (PostBER) depending on a low density parity check (LDPC) level and a distribution of a probability density function (PDF) depending on the RBER according to an embodiment of the present disclosure.

Referring to FIG. 1, a value of RBER increases as more blocks are used, and the value of RBER decreases as fewer blocks are used. PostBER is a final BER value when the value of RBER is corrected using a error correcting code (ECC). When a value of PostBER is smaller, higher reliability can be provided to an application. When the value of PostBER is greater, lower reliability can be provided to the application. An LDPC algorithm is an algorithm in which cells are read using a reference voltage value of all reading levels, data is transferred to a decoder, reading is ended when decoding is successful, the reading level is increased by one level when the decoding fails, and the cells are read again. The LDPC algorithm increases the number of pieces of information to be referenced when data reading fails, thereby improving the accuracy of data reading. For example, when the LDPC algorithm is used, improvement from 40000 program/erase (P/E) cycles to a maximum of 60000 P/E cycles can be achieved. However, in this case, a reading latency may increase.

In the related art (\textcircled{1}), when high reliability is provided to an application, the lifespan of the application is shortened. When some applications have self-resilience (\textcircled{2}) and low reliability is provided to the application having the self-resilience, the lifespan of the application is extended. When the LDPC level becomes high (\textcircled{3}), data reading performance is degraded, but the performance of correcting a bit error is improved, so that the lifespan of the application is extended. In other words, as the area of the PDF increases, the number of blocks that can be allocated to the data increases.

For example, applications based on, for example, data mining, image processing, and machine learning that are executed in a virtual environment at an operating system (OS) level may have self-resilience. Since these applications perform probabilistic calculation or iterative calculation, the applications can perform the self-resilience to relax an error even when the error occurs.

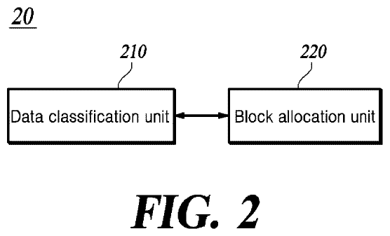

FIG. 2 is a block diagram illustrating a device for classifying data and allocating blocks to the data according to an embodiment of the present disclosure.

Referring to FIG. 2, the device for classifying data and allocating blocks (hereinafter, a data classification and block allocation device 20) includes both or one of a data classification unit 210 and a block allocation unit 220. The data classification and block allocation device 20 and components thereof may be implemented as hardware or software or may be implemented as a combination of the hardware and the software. Further, a function of each component may be implemented as software, and one or more processors may be implemented to execute a function of the software corresponding to the component. The data classification and block allocation device 20 may be a device included in a solid state drive.

The data classification unit 210 classifies data processed and managed by the application into data of which a low bit error rate should be guaranteed and data of which a low bit error rate needs not to be guaranteed. The data of which a low bit error rate should be guaranteed is data of which high reliability should be guaranteed, and the data of which a low bit error rate needs not to be guaranteed is data of which low reliability may be guaranteed. The data classification unit 210 classifies the data using information on quality of service (QoS) received from the user.

The block allocation unit 220 allocates a high reliability block to the data of which high reliability should be guaranteed and a low reliability block to the data of which low reliability may be guaranteed. The block allocation unit 220 manages blocks having a low program/erase (P/E) cycle that can guarantee high reliability and blocks having a high P/E cycle that provide low reliability. The block allocation unit 220 manages the high reliability blocks and the low reliability blocks as a group.

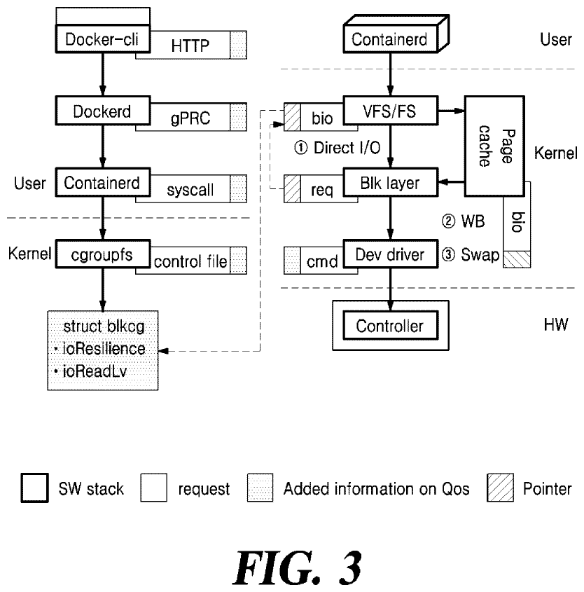

FIG. 3 is a diagram illustrating a method of transferring information on quality of service (QoS) to a solid state drive according to an embodiment of the present disclosure.

Referring to FIG. 3, the user may transfer the information on QoS to the solid state drive so that the data classification unit 210 can classify the data of which high reliability should be guaranteed and the data of which low reliability may be guaranteed. Information on characteristics of blkcg, which is a controller of blkio of a kernel, may include information on two QoS. Here, the information on the two QoS may be information on ioResilence and information on ioReadLv. The information on ioResilence is information on how self-resilient the application is, and the information on ioReadLv is information on an allowable reading latency in the application. The application may set a value of a newly added blkcg using a file system of cgroup. Since cgroup uses a virtual file system (VFS), all cgroups can interact with all file systems equally. Accordingly, a new control file may be defined to control information on newly added ioResilence and the information on ioReadLv.

The user may define characteristics for the information on QoS in blkcg or read the characteristics by performing an operation of reading or writing the control file. The user may transfer the information on QoS to the solid state drive using a docker stack. The docker stack may include a docker client, a docker daemon, and a container daemon. The docker client can communicate with the docker daemon using HyperText Transfer Protocol (HTTP) protocol. The docker client may store the information on QoS in a (Java Script Object Notation (JSON) file format. The container daemon may directly manage a container runtime. A docker engine may performs a Containered CLI (CTR) function to communicate with the container daemon using a local Unix socket. Information on QoS in a JSON file format may be included in a request structure of the local Unix socket and transferred to the container daemon. The container daemon may make a system call to correct a control file of blkcg.

When the control file of blkcg is corrected, a bio structure has a pointer of blkcg so that the information on QoS stored in blkcg can be read. A device driver may transfer the information on QoS to the solid state drive by utilizing information on rsvd2 present in nvme_rw_command. The data classification unit 210 may distinguish the data of which high reliability should be guaranteed from the data of which ow reliability may be guaranteed using the information on rsvd2.

When input/output (I/O) occurs, the information on QoS stored in the kernel may be transferred to hardware using a storage stack. A case where I/O occurs may be a case where direct I/O occurs, a case where white-back occurs, or a case where page swap occurs. When the direct I/O occurs, information on blkcg may be obtained by accessing cgroup_subsys_state present in task-struct. When the white-back occurs or the page swap occurs, a page structure includes information on the cgroup, and thus, the information on blkcg may be obtained by using this information.

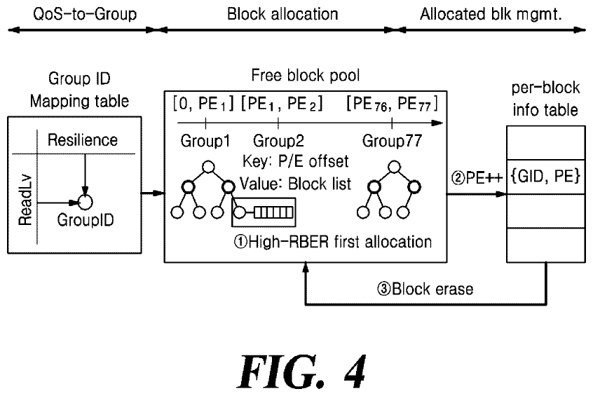

FIG. 4 is a diagram illustrating a method of allocating blocks to data according to the embodiment of the present disclosure.

Referring to FIG. 4, the block allocation unit 220 may manage blocks in a total of 77 groups including 7 reading levels and 11 reliability levels in order to separately manage high reliability blocks and low reliability blocks. The block allocation unit 220 may add a mapping table for conversion of group IDs using the information on QoS. The block allocation unit 220 may determine a group ID using the information on QoS received from a user, acquire a block from a group corresponding to the determined group ID, and allocate the acquired block to the data. Idle blocks for each group may be managed in the form of a red-black tree. The red-black tree is a type of self-balancing binary search tree and is a tree in which nodes have black or red colors. Here, a key of the node is the number of P/E cycles, and a value of the node may be a list of block IDs used during the P/E cycle.

The block allocation unit 220 may preferentially acquire a block having the largest the value of the P/E cycle within each group using an algorithm that preferentially allocates a value of a high RBER. When blocks are moved between groups due to an increase in value of the P/E cycle, nodes of all the groups may fix a P/E offset to 1 to relax an insertion overhead. When there is no idle block within the group corresponding to the determined group ID, the block allocation unit 220 may acquire the block from a group corresponding to a one-level lower group ID. Information on the block acquired by the block allocation unit 220 may be managed using a block-specific table. A value of a P/E cycle of a block acquired from an idle block pool is increased so that the group ID and the P/E offset can be stored in the block-specific table. When block deletion occurs, the block allocation unit 220 may look up the block-specific table and add a block to the idle block pool. By performing such block allocation, the present disclosure can increase the lifespan of the application and achieve low latency requirements.

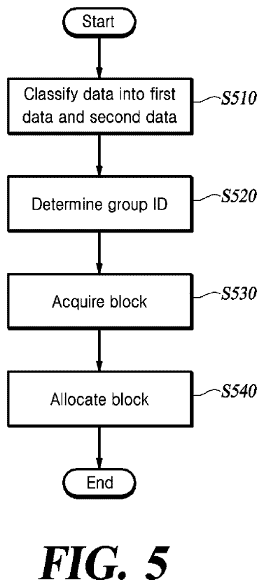

FIG. 5 is a flowchart illustrating a method of classifying data and allocating blocks to the data according to an embodiment of the present disclosure.

Referring to FIG. 5, the data classification unit 210 classifies data into first data and second data using the information on QoS and the bit error rate (S510). The information on QoS may be obtained using a docker stack. The information on QoS may include information on self-resilience of the application and information on a limit on an allowable latency in the application. The block allocation unit 220 determines the group ID using the information on QoS and the mapping table (S520). The block allocation unit 220 acquires a block from an idle block pool of the group based on the group ID using the group ID (S530). A process of acquiring the block may include a process of acquiring the block from an idle block pool within a group based on a group ID at a lower level than the group ID when there is no idle block within the group based on the group ID. The idle blocks within the idle block pool may be managed in the form of the red-black tree. The block allocation unit 220 allocates the block to the first data or the second data (S540).

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method performed by a data classification and block allocation device, the method comprising:
classifying data into first data and second data using information on quality of service (QoS) and a bit error rate;
determining a group ID using the information on QoS and a mapping table;
acquiring a block from an idle block pool of a group based on the group ID using the group ID; and
allocating the block to the first data or the second data.

2. The method of claim 1, wherein the information on QoS is acquired using a docker stack.

3. The method of claim 1, wherein the information on QoS includes information on self-resilience of an application and information on a limit on an allowable latency in the application.

4. The method of claim 1, wherein the acquiring the block comprises:
acquiring the block from an idle block pool within a group based on a group ID at a lower level than the group ID, when there is no idle block within the group based on the group ID.

5. The method of claim 1, wherein the acquiring the block comprises:
acquiring a block having a value of maximum P/E cycle within the group based on the group ID, and
wherein, idle blocks within the idle block pool are managed in the form of a red-black tree.

6. A data classification and block allocation device, comprising:
a memory; and
at least one processor, wherein the at least one processor is configured to:
classify data into first data and second data using information on QoS and a bit error rate,
determine a group ID using the information on QoS and a mapping table,
acquire a block from an idle block pool of a group based on the group ID using the group ID, and
allocate the block to the first data or the second data.

7. The data classification and block allocation device of claim 6, wherein the information on QoS is acquired using a docker stack.

8. The data classification and block allocation device of claim 6, wherein the information on QoS includes information on self-resilience of an application and information on a limit on an allowable latency in the application.

9. The data classification and block allocation device of claim 6, wherein the at least one processor is further configured to:
acquire the block from an idle block pool within a group based on a group ID at a lower level than the group ID when there is no idle block within the group based on the group ID.

10. The data classification and block allocation device of claim 6, wherein the at least one processor is further configured to:
acquire a block having a value of maximum P/E cycle within the group based on the group ID, and
wherein, idle blocks within the idle block pool are managed in the form of a red-black tree.

11. A computer-readable recording medium storing instructions, wherein the instructions, when executed by a computer, cause the computer to perform:
classifying data into first data and second data using information on QoS and a bit error rate;
determining a group ID using the information on QoS and a mapping table;
acquiring a block from an idle block pool of a group based on the group ID using the group ID, and
allocating the block to the first data or the second data.
